(19) United States
(12) Patent Application Publication
(10) Pub. No.: US 2015/0028086 A1
(43) Pub. Date: Jan. 29, 2015

(54) MULTI-USE RECONFIGURABLE PACKAGING

(71) Applicant: Daniel Joel Freschl, (US)

(72) Inventor: Daniel Joel Freschl, Berkeley, CA (US)

(21) Appl. No.: 13/967,673

(22) Filed: Aug. 15, 2013

Related U.S. Application Data
(60) Provisional application No. 61/683,356, filed on Aug. 15, 2012.

(51) Int. Cl. B65D 5/42; B31C 5/00

(52) U.S. Cl. CPC B65D 5/42; B31C 5/00
USPC 229/103; 493/287; 493/295

(57) ABSTRACT

An article of manufacture is provided. The article of manufacture includes a sheet of foldable material. The sheet of foldable material is configured to be folded a first way to form a package for an object. The sheet of foldable material is configured to be folded a second way to form a supplementary structure for a light source.

### CROSS-REFERENCE TO RELATED APPLICATIONS

This application claims priority to U.S. Provisional Patent Application 61/683,356, filed Aug. 15, 2012, which is incorporated by reference herein.

### BACKGROUND OF THE INVENTION

### Field of the Invention

This invention relates generally to packaging, and, more specifically, to making use of packaging materials to provide additional functionality to the object(s) packaged therein.

Packaging waste represents one-third of all trash, costing local governments billions of dollars each year in disposal costs. Although there are many opportunities to recycle packaging, US national recycling rates have not exceeded 34 percent, with the result that much packaging ends up in costly landfills.

People who enjoy venturing into the wilderness are often concerned about the gear that they need to support their enjoyment. In general, whatever gear is desired must be carried. So it is important to wilderness enthusiasts that their gear be lightweight and multifunctional. In general, such people are also concerned about waste in landfills.

It would be extremely useful if packaging for outdoor gear could be converted to provide additional functionality to the gear, thus reducing both packaging waste and the amount of gear that wilderness enthusiasts carry.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic illustration that shows a foldable sheet, according to an embodiment of the invention.

FIG. 2 is a schematic illustration that shows the initial steps of a procedure for folding a foldable sheet into a package, according to an embodiment of the invention.

FIG. 3 is a schematic illustration that shows the use of a foldable sheet as a package for an object, according to an embodiment of the invention.

FIG. 4 is a schematic illustration that shows the removal of a removable portion that can be used to make a supplementary structure.

FIG. 5 is a schematic illustration that shows a removable portion of a foldable sheet that has been made into a supplementary structure to be used as a light-modifying object, according to an embodiment of the invention.

FIG. 6 is a schematic illustration that shows cooperatively disposed fastening features that function to secure the supplementary structure, according to an embodiment of the invention.

FIG. 7 is a schematic illustration that shows an attachment feature used to secure the supplementary structure to a light-emitting device, according to an embodiment of the invention

### SUMMARY

An article of manufacture is disclosed. The article has a first sheet of foldable material that has a plurality of first fold lines, a plurality of second fold lines, and a plurality of removal lines. The first fold lines are configured to allow the first sheet to be folded to make a package for an object. The removal lines at least partially define at least one portion of the first sheet wherein the portion(s) can be removed to form a second sheet(s) of foldable material. The second fold lines are configured to allow the second sheet(s) to be folded to make a supplementary structure that can be used with the object to provide additional functionality to the object. At least a portion of the plurality of removal lines may be perforated. At least one line from the first fold lines may also be part of the second fold lines.

In one arrangement, the object is a light source, such as a headlamp.

In one arrangement, the second sheet is configured to at least partially enclose the light source and to diffuse light from the light source. In another arrangement, the supplementary structure is configured to provide lantern functionality to a headlamp by at least partially enclosing the headlamp and diffusing light from the headlamp.

The first sheet and or the second sheet may also have at least one pair of cooperatively disposed fastening features such as hooks and latches, a pair of mating tabs, and male and female snaps.

The supplementary structure may have at least one fitting that can be used to attach the supplementary structure to the object in a removable way.

In another aspect of the invention, a headlamp package is provided. The package has a first sheet of foldable material that has a plurality of first fold lines, a plurality of second fold lines, and a plurality of removal lines. The first fold lines are configured to allow the first sheet to be folded to make a package for the headlamp. The removal lines at least partially define at least one portion of the first sheet wherein the portion(s) can be removed to form a second sheet(s) of foldable material. The second fold lines are configured to allow the second sheet(s) to be folded to make a lantern that can be used with the headlamp. At least a portion of the plurality of removal lines may be perforated. At least one line from the first fold lines may also be part of the second fold lines.

In another aspect of the invention, a method of forming a lantern shade for a headlamp is provided. The steps include providing a package for the headlamp. The package is made of a sheet of foldable material that has a plurality of first fold lines, a plurality of second fold lines, and a plurality of removal lines. The sheet can be folded along the first fold lines, becoming a package for an object, such as a headlamp. At least one portion of the first sheet can be removed along the removal lines. The removed portion can be folded along the second fold lines, becoming a supplementary structure that can be used with the object, such as a lantern shade that can be used with the headlamp. In one arrangement, the removed portion has at least one pair of cooperatively disposed fastening features. The removed portion can be turned upon itself and attached to itself to form a somewhat cylindrical supplementary structure. In one arrangement, the supplementary structure also has a feature that allows it to be attached to the object.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Embodiments of the invention are related to multi-use reconfigurable packaging. In one embodiment of the present invention, a sheet of foldable packaging material is configured so that it can be folded to form a package for an object, such as a light source. The packaging sheet can be unfolded, and then refolded to form a supplementary structure that can be used with the object to provide additional functionality.

In one embodiment of the invention, the supplementary structure is a cylindrically shaped, faceted lantern shade. The shade can be placed over a light source so that the light beams into the shade. Even if the light source is somewhat focused, the shade helps to diffuse the light so that ambient light can be provided. For example, headlamps usually provide focused light, that is, they illuminate the things directly in front of them and within some angle therefrom. On the other hand, they are not very useful for providing ambient light, that is light that completely surrounds the light source, such as lantern are designed to do. In the dark both kinds of light sources are useful. The headlamp makes it possible to see those things at which its brightness is directed. The lantern provides an overall, diffuse light source so that the overall environment can be seen, though generally not as brightly.

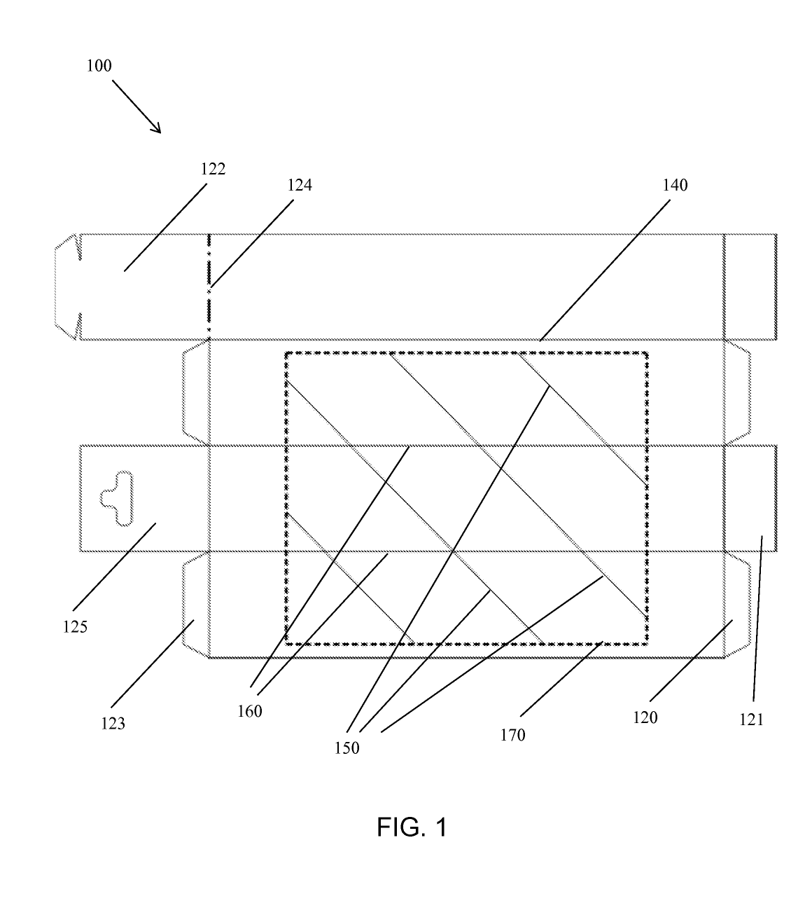

As shown in FIG. 1, a sheet 100 made of a foldable material is provided, according to an embodiment of the invention. The foldable material may be made of, for example, paper, parchment, cardboard, a metal film, and/or a polymer-based material. In some applications, it is useful if the sheet has optical properties that allow for transmission of light.

In one arrangement, the sheet 100 has a plurality of exterior edges that define a specified outside geometry. Fold line 140 for forming a package for an object may be marked on the sheet 100, e.g., by printing, perforating, or scoring the sheet. Fold lines 150 for forming a supplementary structure may be marked on the foldable sheet, e.g., by printing, perforating, or scoring the foldable sheet. Multi-use lines 160 may be used for forming both the package and the supplementary structure. The sheet 100 may have removal lines 170 defining at least one removable portion. Removal lines 170 may be marked on the sheet 100 by printing, perforating, or scoring.

In certain embodiments of the invention, the sheet 100 has features that modify the function of the package and/or the supplementary structure, such as apertures or panels. The term “panel” is used herein to signify any distinct portion of the sheet 100 that is bordered by fold lines or edges. The sheet 100 may contain an aperture (not shown) that facilitates the viewing of an object internal to the package and/or the supplementary structure. The sheet 100 may contain panels defining the bottom of the package 120 and 121. The sheet 100 may contain panels defining the top of the package 123. The sheet 100 may contain a panel 122 configured to be opened and closed along a fold line that defines a hinge 124. The sheet 100 may contain a display panel 125 that can be used to facilitate display of the package by attaching to a hook or hanger. In certain embodiments of the invention, the sheet 100 may have at least one pair of cooperatively disposed fastening features such as a hook and latch, a pair of mating tabs, or male and female snaps. These features may be constructed from the sheet 100 by means of scoring, marking, or cutting the features into the sheet. These features may also be attached to the sheet 100 using a mechanical connection, an adhesive or other fastening method.

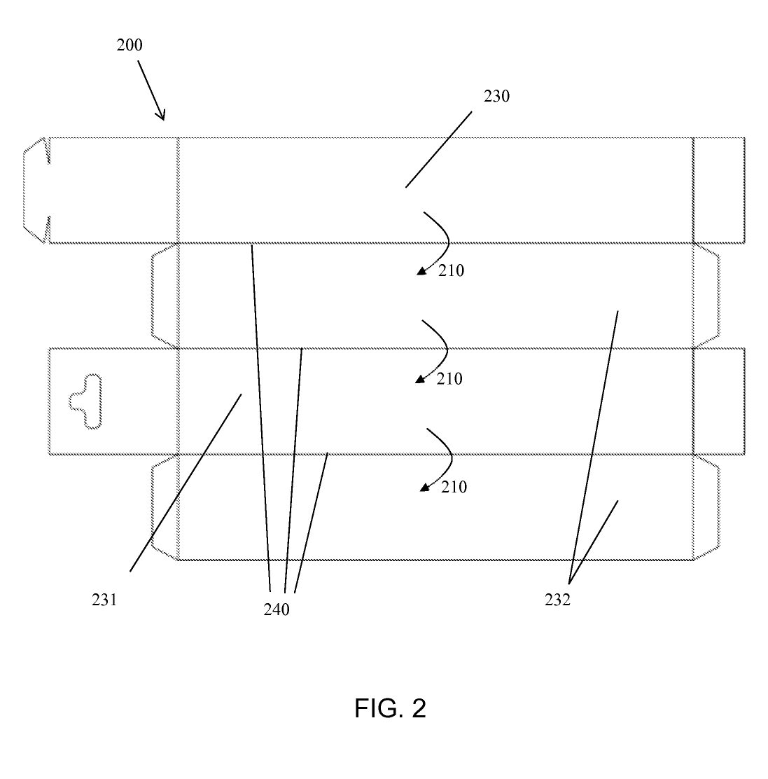

FIG. 2 is a schematic illustration that shows some initial steps of a procedure for folding a sheet 200 into a package, according to an embodiment of the invention. The sheet 200 can be folded in predefined directions 210 that run perpendicular to fold lines 240. The initial steps of the folding procedure define a front 230, sides 132, and a back 231 of an exemplary package.

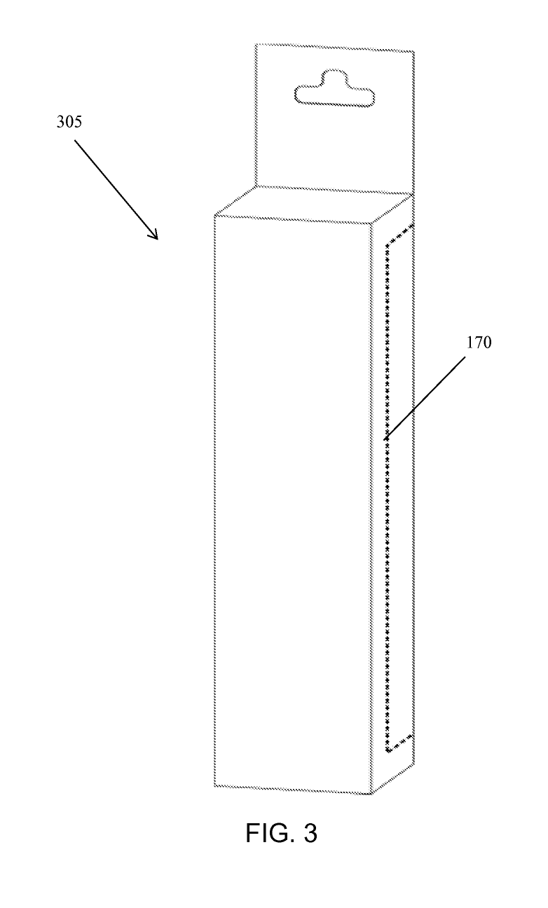

FIG. 3 illustrates a schematic illustration of a perspective view of an exemplary package 305 formed by folding the sheet 200 along the first set of fold lines 240, as shown in FIG. 2. The removal lines 170, as shown in FIG. 1, are also illustrated. In certain embodiments of the invention the removal lines 170 are inset from some or all of the fold lines 140, 150, 160 of FIG. 1. In other embodiments of the invention the removal lines are collinear with some or all of the fold lines 140, 150.

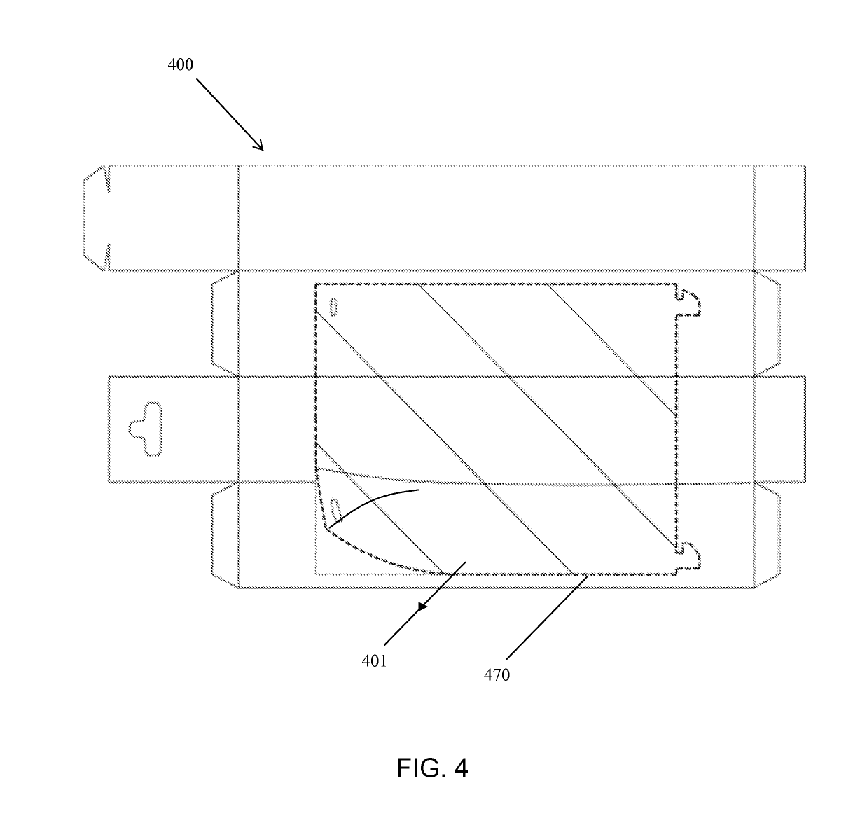

As shown in the exemplary embodiment in FIG. 4, a sheet 400 may be separated into two parts along removal lines 470. In one arrangement (not shown), the sheet 400 can be separated into more than two parts along a variety of removal lines. A removable portion 401 is removed from the sheet 400 and is used to make a supplementary structure. A set of external edges are defined by the original removal lines 470. In some arrangements, the external edges 470 also define fastening features that can be used in making the supplementary structure. The removal lines 470 may also reduce or eliminate features that define the geometry of the package without reducing features used to define the supplementary structure.

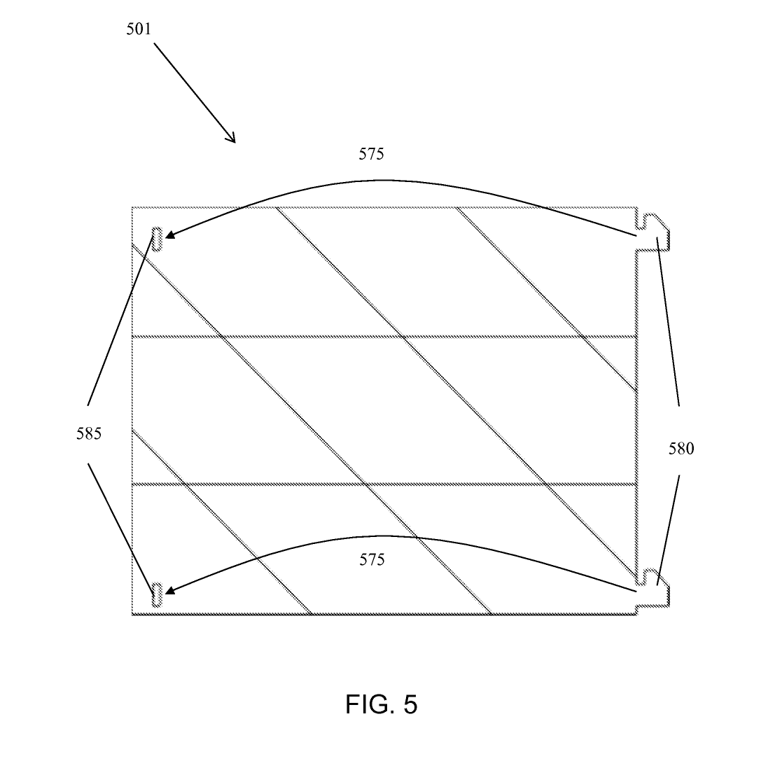

FIG. 5 is a schematic illustration that shows an example of cooperatively disposed fastening features on a removed portion 501: male fastening features 580 and female fastening features 585. Lines 575 indicate a direction in which to fold the removed portion 501 so that the male features 580 the female features 585 can be connected to form a supplementary structure, according to an embodiment of the invention. Such cooperatively disposed male and female fastening features may be a hook and latch, a pair of mating tabs, male and female snaps, or Velcro™, for example.

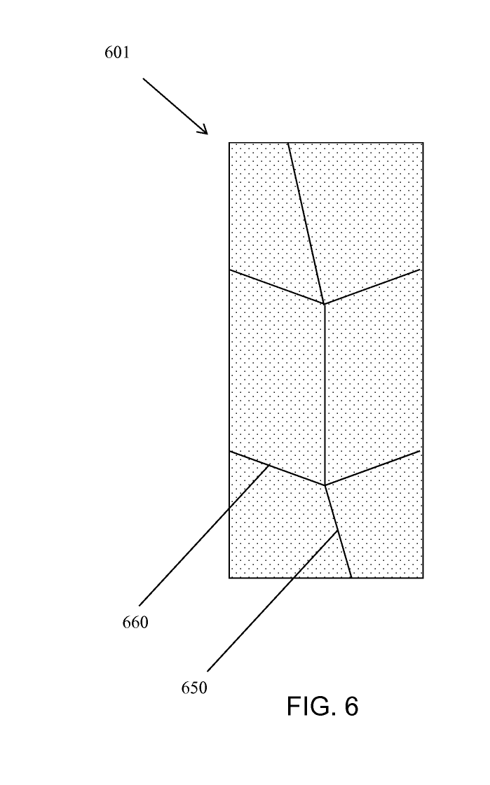

FIG. 6 is a schematic illustration of a supplementary structure 601, according to an embodiment of the invention. The supplementary structure 601 has fold lines 650 and may also have multi-use fold lines 660 that help to define the geometry of the supplementary structure 601. The supplementary structure 601 may be a fully closed shape or may have one or more openings or apertures. The supplementary structure 601 may partially obstruct the view of an enclosed object (not shown) from a viewer. In one arrangement, the supplementary structure 601 may fully enclose the object. The supplementary structure 601 may have a fastening feature (not shown) that forms a mechanical connection to the object. In one embodiment of the invention, the supplementary structure 601 is a lantern shade. The shade can be placed over a light-emitter, such as a headlamp, and can diffuse the light therefrom so that the overall effect of the headlamp-shade combination is that of a glowing lantern, providing ambient, rather than focused light.

A headlamp by itself may provide light that is too focused to be used as a glowing lantern. By reconfiguring the packaging in which the headlamp is sold, a supplementary structure (lantern shade) is made and extra functionality is provided to the headlamp. Outdoor enthusiasts can have both a headlamp and a lantern by carrying only the headlamp and the reused headlamp packaging. Thus both carrying weight and waste are reduced.

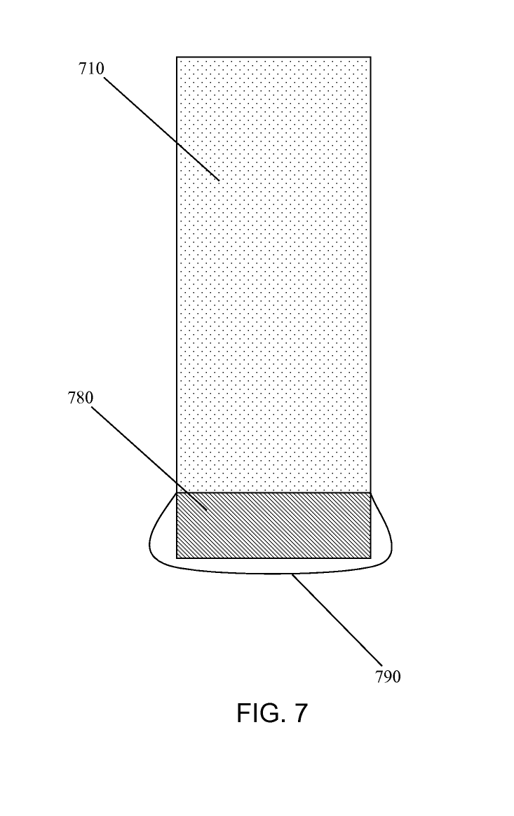

FIG. 7 is a schematic illustration that shows an example of a fitting 790 that can be used to attach a supplementary structure 710 to a light-emitting object 780, according to an embodiment of the invention. The fitting 790 may be a flexible or rigid member. The fitting 790 may completely encircle the light-emitting device 780. The fastening feature may mate to a mechanical feature (not shown) on the light-emitting device 780. The fitting 790 may be constructed from the original sheet 100 from FIG. 1 by means of scoring, marking, or cutting the features into the sheet 100. The fitting 790 may also be attached to the supplementary structure 710 using an additional mechanical connection (not shown), an adhesive or other fastening method. There may be a plurality of fastening features.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. An article of manufacture comprising:
a first sheet of foldable material comprising a plurality of first fold lines, a plurality of second fold lines, and a plurality of removal lines;
wherein the plurality of first fold lines is configured to allow the first sheet to be folded to make a package for an object;
the plurality of removal lines at least partially defines at least one portion of the first sheet wherein the portion(s) can be removed to form a second sheet(s) of foldable material; and
the plurality of second fold lines is configured to allow the second sheet(s) to be folded to make a supplementary structure that can be used with the object to provide additional functionality to the object.

2. The article of claim 1 wherein the object is a light source.

3. The article of claim 2 wherein the object is a headlamp.

4. The article of claim 2 wherein the second sheet is configured to at least partially enclose the light source and to diffuse light from the light source.

5. The article of claim 3 wherein the supplementary structure is configured to provide ambient lighting functionality to the headlamp by at least partially enclosing the headlamp and diffusing light from the headlamp.

6. The article of claim 1 wherein at least a portion of the plurality of removal lines is perforated.

7. The article of claim 1 wherein at least one line from the plurality of first fold lines is also included in the plurality of second fold lines.

8. The article of claim 1 wherein the first sheet further comprises at least one pair of cooperatively disposed fastening features selected from the group consisting of a hook and latch, a pair of mating tabs, and male and female snaps.

9. The article of claim 1 wherein the second sheet further comprises at least one pair of cooperatively disposed fastening features selected from the group consisting of a hook and latch, a pair of mating tabs, and male and female snaps.

10. The article of claim 1 wherein the supplementary structure comprises at least one fitting that can be used to attach the supplementary structure to the object in a removable way.

11. A reconfigurable package comprising:
a first sheet of foldable material comprising a plurality of first fold lines, a plurality of second fold lines, and a plurality of removal lines;
wherein the plurality of first fold lines is configured to allow the first sheet to be folded to make a package for a headlamp;
the plurality of removal lines at least partially defines at least one portion of the first sheet wherein the portion(s) can be removed to form a second sheet(s) of foldable material; and
the plurality of second fold lines is configured to allow the second sheet(s) to be folded to make a lantern shade for the headlamp.

12. A method of forming a lantern shade for a headlamp, comprising the steps of:
a) providing a package for the headlamp wherein the package comprises:
a first sheet of foldable material comprising a plurality of first fold lines, a plurality of second fold lines, and a plurality of removal lines;
wherein the plurality of first fold lines is configured to allow the first sheet to be folded to make a package for an object;
the plurality of removal lines at least partially defines at least one portion of the first sheet wherein the portion(s) can be removed to form a second sheet(s) of foldable material; and
the plurality of second fold lines is configured to allow the second sheet(s) to be folded to make a supplementary structure that can be used with the object to provide additional functionality to the object;
b) removing the portion to form a second sheet;
c) folding the second sheet along the plurality of second fold lines; and
d) attaching the second sheet to itself using at least one pair of cooperatively disposed fastening features to form a lantern shade.

13. The method of claim 12 further comprising the step:
e) removably attaching the lantern to the headlamp.
